(19) United States
(12) Patent Application Publication
(10) Pub. No.: US 2026/0063767 A1
(43) Pub. Date: Mar. 5, 2026

(54) LIDAR AND MOVABLE DEVICE

(71) Applicant: SUTENG INNOVATION TECHNOLOGY CO., LTD., Shenzhen (CN)

(72) Inventors: Junting DONG, Shenzhen (CN); Jikai GUO, Shenzhen (CN); Kang LIU, Shenzhen (CN)

(73) Assignee: SUTENG INNOVATION TECHNOLOGY CO., LTD., Shenzhen (CN)

(21) Appl. No.: 19/315,635

(22) Filed: Aug. 31, 2025

(30) Foreign Application Priority Data
Sep. 2, 2024 (CN) 202411226149.1

(51) Int. Cl. G01S 7/481

(52) U.S. Cl. CPC G01S 7/4811; G01S 7/4815; G01S 7/4816; G01S 7/4817

(57) ABSTRACT

The present application discloses a LiDAR and a movable device. The LiDAR includes an emission module, a receiving module, a beam splitter and a scanning module. The receiving lens meets 40 mm≤f_{RX}≤80 mm, where f_{RX} is the effective focal length of the receiving lens. The beam splitter includes a light transmitting portion and a reflecting portion, the reflecting portion being disposed at the periphery of the light transmitting portion. The scanning module is configured to emit the detected light to the target object, and to transmit the echo light to the receiving module.

### CROSS-REFERENCE TO RELATED APPLICATION

The present application claims the benefit of priority to Chinese Patent Application No. 202411226149.1 filed on Sep. 2, 2024, which is hereby incorporated by reference in its entirety.

### TECHNICAL FIELD

The present application relates to the field of LiDAR technology, and in particular to a LiDAR and a movable device.

### BACKGROUND

Due to the widespread application of LiDAR systems in autonomous driving and other advanced end-uses, it is necessary for the design to satisfy the requirement of accurately detecting both distant and nearby targets. In LiDAR systems, the receiving system typically adopts a telescope system to optimize the detection performance of distant targets. In this configuration, the object distance is normally assumed to be close to infinity during its design, which means that the system is primarily optimized to obtain the best long-distance imaging performance.

However, this long-range-focused design configuration introduces a significant limitation: potential defocusing issues when detecting near-range targets.

### SUMMARY

Embodiments of the present application provide a LiDAR and a movable device to address the problem of an out-of-focus phenomenon during detection of a close-range target caused by a design configuration that focuses on long-range detection in a detection system designed to detect targets with a large variation in distance and size.

In a first aspect, an embodiment of the present application provides a LiDAR, including an emission module, a receiving module, a beam splitter, and a scanning module. The emission module is configured to emit detection light. The receiving module is configured to receive the echo light formed by the reflected detection light from the target object. The receiving module includes a receiving lens and a receiver, and the receiving lens is located on the light-entry side of the receiver, and the receiving lens satisfies a conditional formula: 40 mm≤f_{RX}≤80 mm, wherein f_{RX} is the effective focal length of the receiving lens. The beam splitter includes a light transmitting portion and a reflecting portion, and the reflecting part is provided at the periphery of the light-transmitting portion, the light-transmitting portion is used for transmitting the light, the light-transmitting part is configured to transmit the detected light, and the reflecting portion is configured to reflect the echo light. The scanning module is used for emitting the detected light to the target object and transmitting the echo light to the receiving module.

The embodiments of the present application provide a LiDAR in which the effective focal length of the receiving lens f_{RX} is set to be greater than or equal to 40 mm and less than or equal to 80 mm, thereby reducing the effective focal length of the receiving lens f_{RX}. Combined with the geometric optics formula h=f*tan θ, it can be seen that when the effective focal length of the receiving lens f_{RX} is reduced, the size of the spot received on the receiving surface can be achieved to reduce the size of the spot, so that all or most of the spot can be received by the receiving surface, thereby enhancing the energy of the echoed light received by the receiver.

In some of these embodiments, the interface between the light transmitting portion and the light reflecting portion is a cylindrical surface. The beam splitter meets: 10 mm≤R≤12 mm, where R is the radial dimension of the interface between the light-transmitting portion and the light-reflecting portion.

Based on the above embodiments, the size of the transmitting portion in the middle of the beam splitter is reduced, thereby reducing the object height of the beam splitter for the rear mirror group. As a result, the size of the hole in the middle of the spot (corresponding to the transmitting portion) on the receiver is reduced, enhancing the area of the spot on the receiver, and realizing the enhancement of the return energy on the receiver, while ensuring a certain launching efficiency.

In some of these embodiments, the light transmitting portion is a light transmitting hole on the beam splitter, and the light transmitting hole has a circular cross-section in the radial direction.

Based on the above embodiments, opening a light-transmitting hole directly on the beam splitter to pass the detection light reduces optical loss and processing cost compared to setting part of the beam splitter as a light-transmitting material to transmit the detection light.

In some embodiments, the receiver has a receiving surface, the receiving surface satisfying: 0.05 mm≤H₁≤0.2 mm, where H₁ is the spacing between the center of the first spot and the center of the receiving surface in the first direction, the first spot is the spot where the echo light is incident on the receiving surface, and the first direction is the dimensional direction of the receiving surface.

The above design enables the center of the middle hole of the first spot to be shifted relative to the receiving surface, so that at least a part of the middle hole moves out of the receiving surface and a greater portion of the first spot is positioned on the receiving surface, thus enhancing the area of the spot that strikes the receiving surface, and thereby achieving the enhancement of the echo energy on the receiver.

In some embodiments, the emission module includes: an emission unit including a plurality of lasers, the lasers being used to generate a detection light; and an emitting lens, located on the light-emitting side of the emitting unit, used to emit detection light. In this case, the lasers are arranged in a linear arrangement or in a two-dimensional array.

Based on the above embodiments, setting multiple lasers in the emission unit corresponding to the same receiver can enable the receiver to receive the echo light corresponding to all the lasers in the emission unit, i.e., the receiver receives the composite echo light formed by all the lasers in the emission unit, so as to achieve the multi-transmitter and one-receiver. Compared with the one-transmitter-one-receiver, the multiple-transmitter-one-receiver is conducive to improving the energy of the echo light received by the receiver, thus optimizing the transceiver efficiency of the LIDAR.

In some of these embodiments, the scanning module includes: a rotating mirror for rotating on a first straight line, the rotating mirror having a plurality of second reflective surfaces disposed around the first straight line, the first straight line being perpendicular to a plane in which an optical axis of the LiDAR is located, the first straight line being perpendicular to a plane in which an optical axis of the LiDAR is located; and a galvanometer for rotating on the axis of a second straight line, the galvanometer having a second reflective surface, the second straight line being perpendicular to the first straight line.

In some embodiments, two adjacent second reflective surfaces are connected by a transition surface.

Based on the above embodiments, two adjacent second reflective surfaces directly connected to the formation of the sharp corners are easy to form a diffuse reflection, whereas providing a transition surface that is conducive to achieving controlled reflection of the beam.

In some embodiments, the LiDAR further includes a first extinction unit and a second extinction unit. The first extinction unit is disposed between the emission unit and the transmitting lens; and the second extinction unit is disposed between the receiving surface and the receiving lens.

Based on the above embodiments, the first extinction unit is used to eliminate stray light between the emission unit and the transmitting lens. The second extinction unit is used to eliminate stray light between the receiving surface of the receiver and the beam splitter.

In some embodiments, the LiDAR further includes a housing, the housing including a mounting cavity and a window. The emission module, the receiving module, the beam splitter, and the scanning module are all disposed in the mounting cavity. The angle between the normal vector and the detected light at a first point on the window and the detected light is greater than a predetermined value, where the first point is the intersection of the detected light and the window with the surface of the window proximate to the mounting cavity, and the predetermined value is determined according to the energy of the detected light.

Based on the above embodiments, by optimizing the surface shape of the LIDAR window, the angle of the normal vector at the intersection of the detected light and the inner surface of the window is increased by a non-uniform surface on the inner surface of the window, so as to meet the requirement that the angle of the normal vector at the intersection of the detected light and the window at the time of the detected light in different fields of view is larger than the preset angle, and to avoid the reflection of the light from a vertical window as much as possible from the design perspective, thereby minimizing the effect of the leading phenomenon.

In a second aspect, embodiments of the present application provide a movable device including an apparatus body and a LiDAR. The LiDAR is connected to the apparatus body, and the LiDAR including: an emission module, configured to emit detection light; a receiving module, configured to receive the echo light formed by the reflected detection light from the target object, where the receiving module includes a receiving lens and a receiver, the receiving lens is located on the light-entry side of the receiver, the receiving lens satisfies a conditional formula: 40 mm≤f_{RX}≤80 mm, where f_{RX} is the effective focal length of the receiving lens; a beam splitter, including a light transmitting portion and a reflecting portion, the reflecting portion being disposed at the periphery of the light transmitting portion, the light transmitting portion being configured to transmit the detected light, and the reflecting portion being configured to reflect the echo light; and a scanning module, configured to emit the detected light to the target object, and to transmit the echo light to the receiving module.

In the embodiments of the present application, by setting the effective focal length f_{RX} of the receiving lens to be greater than or equal to 40 mm and less than or equal to 80 mm, the effective focal length f_{RX} of the receiving lens is reduced. Combined with the geometric optical formula h=f*tan θ, it can be seen that when the effective focal length f_{RX} of the receiving lens is reduced, the size of the light spot received on the receiving surface is reduced, so that the light spot can be received by the receiving surface in its entirety or for the most part, thereby increasing the energy of the echo light received by the receiver.

### BRIEF DESCRIPTION OF THE DRAWINGS

In order to more clearly illustrate the embodiments of the present application or the technical solutions in the prior art, a brief description of the accompanying drawings is provided below. The accompanying drawings illustrate only certain embodiments of the present application, and those skilled in the art will understand that other drawings may be derived from these illustrations without departing from the scope of the present application and without requiring inventive effort.

FIG. 1 is a schematic diagram of a local structure of a LiDAR according to some embodiments of the present application;

FIG. 2 is a schematic diagram of the structure of an emission module in a LiDAR according to some embodiments of the present application;

FIG. 3 is a schematic structural diagram of the spot received on the receiving surface in the LiDAR illustrated in FIG. 2;

FIG. 4 is a schematic diagram of the structure of a receiving module in a LiDAR according to some embodiments of the present application;

FIG. 5 is a schematic structural diagram of a close or very close detected spot received on the receiving surface in the LiDAR illustrated in FIG. 4;

FIG. 6 is a schematic structural diagram of a spot detected at a distance received on the receiving surface in the LiDAR illustrated in FIG. 4;

FIG. 7 is a schematic diagram of the structure of a beam splitter in a LiDAR according to some embodiments of the present application;

FIG. 8 is a schematic diagram of the structure of another beam splitter according to some embodiments of the present application;

FIG. 9 is a graph of the variation of the emission efficiency and the proximity return energy with the radial dimension of the sub-interface between the light transmitting portion and the reflecting portion in the LiDAR according to some embodiments of the present application;

FIG. 10 is a graph of the variation of the transceiver efficiency with the radial dimension of the sub-interface between the light transmitting portion and the reflecting portion in the LiDAR according to some embodiments of the present application;

FIG. 11 is a schematic diagram of a local structure of a LiDAR according to some embodiments of the present application; and

FIG. 12 is a schematic diagram of a structure of a movable device according to some embodiments of the present application.

### REFERENCE NUMERALS

1, LiDAR; 2, movable device; 3, apparatus body;
10, emission module; 11, emission unit; 111, laser; 111a, laser; 111b, laser; 12, emission lens;
20, receiving module; 21, receiving lens; 22, receiver; 221, receiving surface; 2211, light spot; 2211a, light spot; 2211b, light spot;
30, beam splitter; 31, light transmitting portion; 32, reflecting portion; 33, first surface; 34, second surface; 35, light transmitting hole;
40, scanning module; 41, galvanometer; 411, first reflective surface; 42, rotating mirror; 421, second reflective surface; 422, transition surface;
50, first extinction unit; 51, first through-hole; 511, extinction groove; 52, first end face; 53, second end face; 531, second mounting groove;
60, second extinction unit; 61, first extinguisher; 611, first extinction section; 62, second extinguisher; 621, extinction unit; 6211, extinguishing teeth;
70, housing; 71, mounting cavity; 72, window;
x, first straight line; y, second straight line.

### DETAILED DESCRIPTION

In order to further clarify the purpose, technical solutions, and advantages of the present application, a more detailed description is provided below with reference to the accompanying drawings and exemplary embodiments. It should be understood that the specific embodiments described herein are intended solely for illustrative purposes and are not intended to limit the scope of the present application in any way.

In a LiDAR, the receiving system typically is configured as a telescope system to optimize detection performance for distant targets. However, this design configuration, which prioritizes long-range detection, has a significant limitation in that it may cause defocusing when detecting nearby targets.

Out-of-focus phenomena occur when the position of an object does not match the focal length setting of the system, causing the imaging system to be unable to form a clear focus on the detector, thereby affecting image clarity and target recognition capabilities. For LiDAR systems, when nearby targets are within the system's minimum focal length, the beam may fail to accurately focus on the detector, resulting in blurred imaging and reduced detection performance. At the same time, for LiDAR optical systems with collimated receiving and transmitting lenses (coaxial systems), a flat mirror called a beam splitter is used to separate the optical paths. In the case of a near-range blurred spot, the center of the received spot is missing, which causes a decrease in the energy received by the detector, even though the energy of the near-range spot incident on the entrance pupil of the optical system is increased.

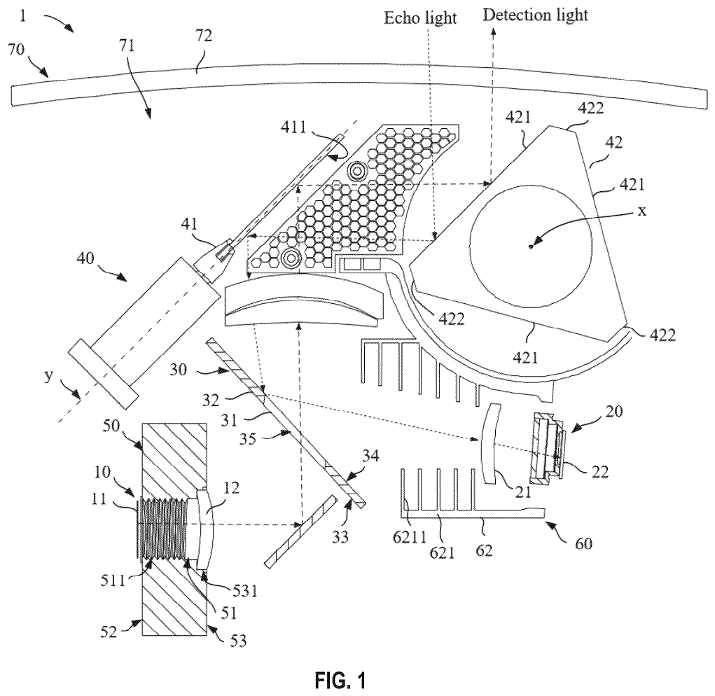

Referring to FIG. 1, embodiments of the present application provide a LiDAR 1, which includes an emission module 10, a receiving module 20, a beam splitter 30, and a scanning module 40. The emission module 10 is configured to emit detection light; and the receiving module 20 is configured to receive echo light formed by reflection of the detection light from a target object. The receiving module 20 includes a receiving lens 21 and a receiver 22, the receiving lens 21 is located in the light side of the receiver 22. The Beam splitter 30 includes a light transmitting portion 31 and a reflecting portion 32, the reflecting portion 32 is located in the periphery of the light transmitting portion 31, the light transmitting portion 31 is used for transmitting detecting light, and the reflecting portion 32 is used for reflecting return light. The scanning module 40 is used for ejecting the detecting light to the target object, as well as transmitting the return light to the receiving module 20.

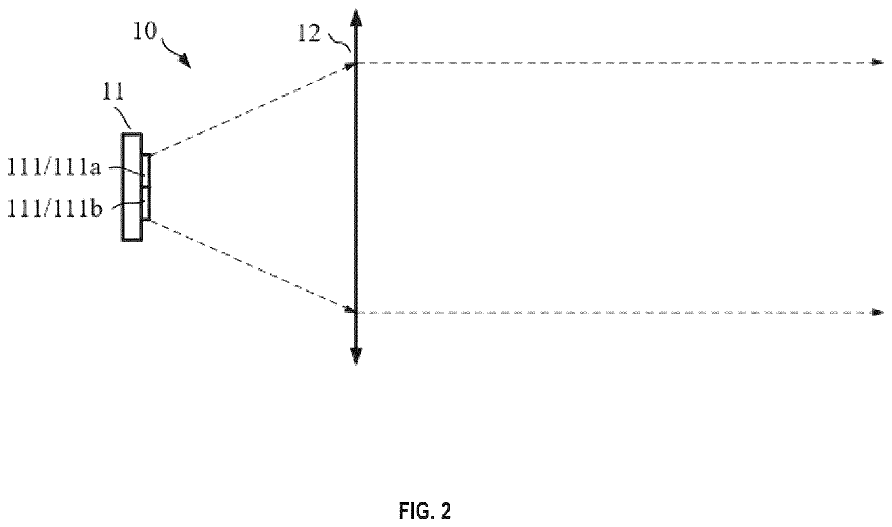

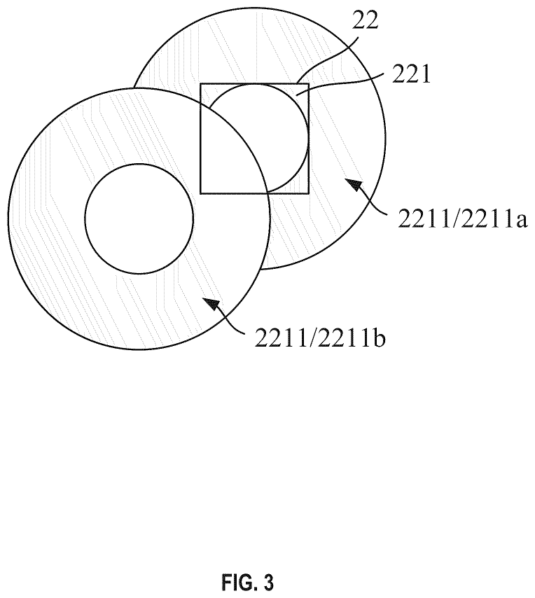

Next, referring to FIGS. 2 and 3, the above-described emission module 10 is further described.

Referring to FIG. 2, the emission module 10 includes an emission unit 11 and an emission lens 12. The emission unit 11 includes a laser 111, which is used to generate the detection light. The emission lens 12 is located on the light side of the emission unit 11, which is used to transmit the detection light. Among them, the laser 111 can be used in various forms of laser transmitters. For example, it can be a vertical cavity surface emitting laser (VCSEL), edge emitting laser (EEL), laser diode (LD) light source, etc., without limitation.

In some embodiments, the emission unit 11 includes a plurality of lasers 111, and the plurality of lasers 111 in the emission unit 11 corresponds to the same receiver 22. Since the detected light generated by each laser 111 in the emission unit 11 corresponds to the return light, setting the plurality of lasers 111 in the emission unit 11 to correspond to the same receiver 22 enables the receiver 22 to receive the return light corresponding to all the lasers 111 in the emission unit 11, so as to realize multiple return light. All of the lasers 111 in the emission unit 11 correspond to the return light. That is, the receiver 22 receives the composite return light formed by all of the lasers 111 in the emission unit 11, and realizes multi-transmitter and one-receiver. Compared with the one-transmitter-one-receiver, the multiple-transmitter-one-receiver is conducive to increasing the energy of the echo light received by the receiver 22, thereby optimizing the transceiver efficiency of the LiDAR 1.

It will be appreciated that each return wave of light incident on the receiving surface 221 of the receiver 22 forms a light spot 2211. In some embodiments, the at least two lasers 111 within the emission unit 11 correspond to at least two light spots 2211 on the receiving surface 221 that are at least partially overlapping. For example, the emission unit 11 includes a laser 111a and a laser 1l1b, the laser 111a corresponding to the light spot 2211a on the receiving surface 221, and the laser 1l1b corresponding to the light spot 2211b on the receiving surface 221, with the light spot 2211a at least partially overlapping with the light spot 2211b.

Since the light transmitting portion 31 of the beam splitter 30 is used for transmitting the detection light and the reflecting portion 32 is used for reflecting the return light, and the reflecting portion 32 is disposed at the periphery of the light transmitting portion 31, the light spot 2211 formed on the receiving surface 221 by the return light reflected by the reflecting portion 32 of the detection light produced by each of the lasers 111 is approximately circular. By designing at least a partial overlap of the light spots 2211 corresponding to a plurality of lasers 111, the effective receiving area of the return light received by the receiving surface 221 can be enhanced by making one light spot 2211 cover the intermediate aperture of another light spot 2211, thereby enhancing the energy of the return light received by the receiver 22.

In some embodiments, the plurality of lasers 111 in the emission unit 11 may be randomly arranged or regularly arranged. For example, the plurality of lasers 111 in the emission unit 11 may be arranged in a linear or two-dimensional array, without limitation. It should be noted that the multiple lasers 111 in the emission unit 11 can be lit at the same time, can also be lit in time sequence.

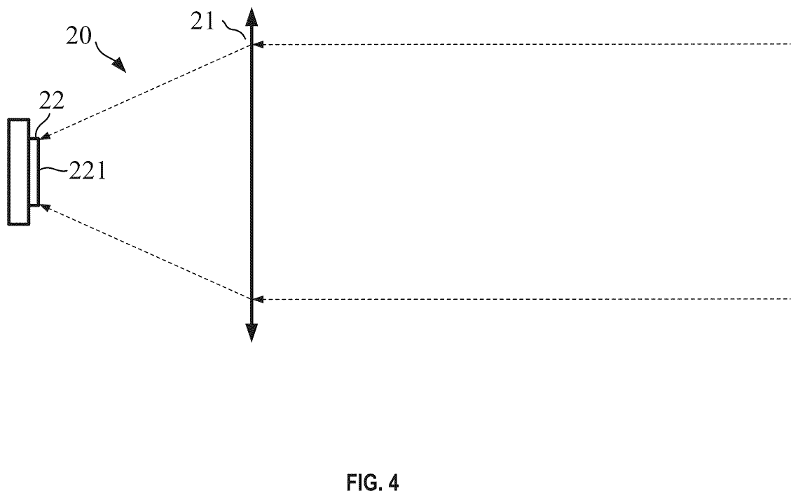

Next, referring to FIGS. 4 to 6, the above-described receiving module 20 is further described.

Referring to FIG. 4, the receiving module 20 includes a receiving lens 21 and a receiver 22. The receiving lens 21 is located on the light-entry side of the receiver 22, and the receiving lens 21 is used to transmit the return light to the receiver 22. The receiver 22 may adopt a silicon photomultiplier (SiPM), an avalanche photo diode (APD), a single photon avalanche diode (SPAD), and the like, without limitation.

In some embodiments, the receiving lens 21 satisfies 40 mm≤f_{RX}≤80 mm, where f_{RX} is an effective focal length of the receiving lens 21. Designing the effective focal length f_{RX} of the receiving lens 21 to be greater than or equal to 40 mm and less than or equal to 80 mm achieves a reduction in the effective focal length fax of the receiving lens 21 (in related technology, the effective focal length of the receiving lens is usually in the range of 110 mm-120 mm). Combined with the geometrical optics formula h=f*tan θ, it can be understood that when the effective focal length fax of the receiving lens 21 is decreased, the size of the light spot received on the receiving surface 221 is correspondingly reduced, which allows the light spot to be received by the receiving surface 221 in its entirety or a greater part of it, and thus enhances the energy of the return light received by the receiver 22. In some embodiments, the effective focal length fax of the receiving lens 21 may be 56 mm, 59.5 mm, 63 mm, 66.5 mm, 70 mm, and the like.

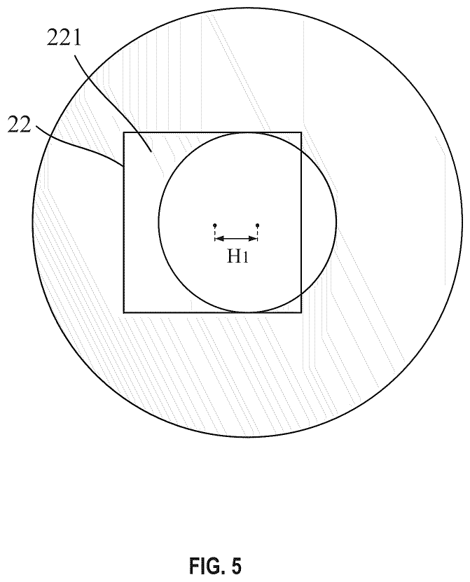

Referring to FIG. 5, in some embodiments, the receiver 22 has a receiving surface 221, and the receiving surface 221 satisfies: 0.05 mm≤H₁≤0.2 mm, where H₁ is the spacing between the center of the first light spot and the center of the receiving surface 221 in a first direction, the first light spot is the light spot of the return light incident to the receiving surface 221, and the first direction is the dimension of the receiving surface 221. The first direction is the dimension of the receiving surface 221. The first direction is the dimensional direction of the receiving surface 221, where the receiving surface 221 may be generally rectangular, and the first direction may be the length direction or the width direction of the rectangle.

Since the light transmitting portion 31 of the beam splitter 30 is used for transmitting the detected light and the reflecting portion 32 is used for reflecting the return light, and the reflecting portion 32 is disposed at the periphery of the light transmitting portion 31, the first light spot formed on the receiving surface 221 by the return light reflected by the reflecting portion 32 is approximately circular. The distance H₁ between the center of the first light spot and the center of the receiving surface 221 in a first direction is greater than or equal to 0.05 mm and less than or equal to 0.2 mm, which enables the middle hole of the first light spot to be offset relative to the center of the receiving surface 221, so that at least a portion of the middle hole is shifted out of the receiving surface 221, and the first light spot is located on the receiving surface 221 more often, which enhances the area of the light spot that hits the receiving surface 221. 221, increasing the area of the light spot hitting the receiving surface, thereby achieving an increase in echo energy at the receiver 22. In some embodiments, the spacing H₁ between the center of the first light spot and the center of the receiving surface 221 in the first direction may be 0.05 mm, 0.0625 mm, 0.075 mm, 0.0875 mm, 0.1 mm, and the like.

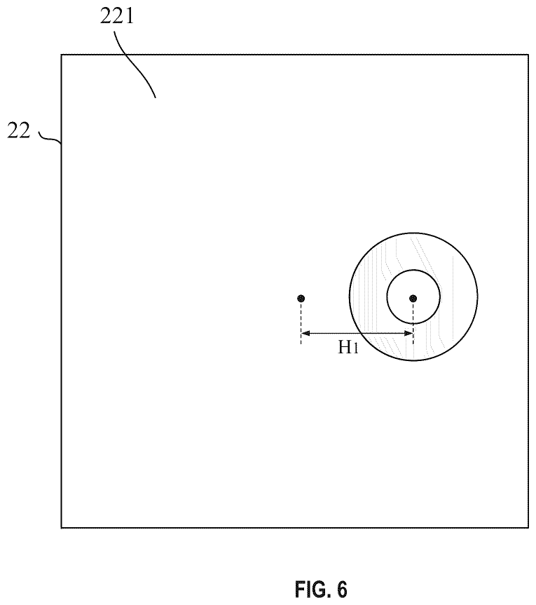

It should be noted that, for long-distance detection, the size of the spot formed by the echo light on the receiving surface 221 is small, generally ensuring that the entire spot is on the receiving surface 221, and there are fewer cases where the spot falls outside the range of the receiving surface 221. For close-range or very close-range detection, the spot size of the echo light formed on the receiving surface 221 is larger, and the hole in the middle of the spot is also larger. In some cases, the hole in the middle of the spot may even be larger than the size of the receiving surface 221. At such time, if the center of the spot and the center of the receiving surface 221 overlap, the majority of the annular spot will not fall on the receiving surface 221, resulting in the loss of echo energy. The above design can be used to ensure that the light spot center is coincident with the center of the receiving surface 221. However, the above design can ensure that the light spot will not be shifted out of the receiving surface 221 during long-distance detection (see FIG. 6), and achieves that at least part of the middle hole of the light spot, when detecting at a close distance or extremely close distance, is shifted out of the receiving surface 221, while the outer ring of the light spot is partially shifted into the receiving surface 221 (see FIG. 5). As a result, the light spot on the receiving surface 221 when detecting at a close distance or extremely close distance can be effectively improved, and the echo energy received on the receiving surface 221 during the close or very close detection is effectively enhanced. In other words, the distance H₁ between the center of the first spot and the center of the receiving surface 221 in the first direction is greater than or equal to 0.05 mm and less than or equal to 0.2 mm, which can optimize the detection performance of the LiDAR 1 over the full detection range.

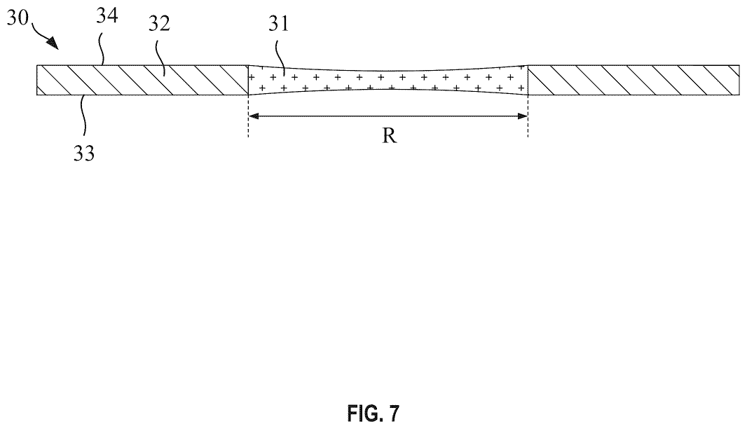

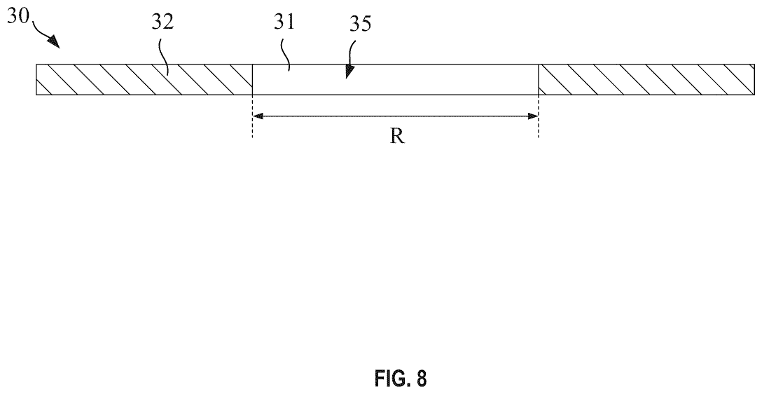

Referring to FIGS. 7 and 8, the beam splitter 30 includes a light transmitting portion 31 and a reflecting portion 32, the reflecting portion 32 is disposed at the periphery of the light transmitting portion 31, the light transmitting portion 31 is used for transmitting the detected light, and the reflecting portion 32 is used for reflecting the return light.

In an embodiment, referring to FIG. 7, the light transmitting portion 31 of the beam splitter 30 may be recessed relative to the reflecting portion 32 to reduce the thickness of the medium through which the light passes when passing through the light transmitting portion 31, and to reduce the loss. Specifically, the beam splitter 30 has opposite first surfaces 33 and second surfaces 34, and the detection light can pass along the direction from the first surface 33 to the second surface 34, where the light transmitting portion 31 is recessed relative to the reflecting portion 32, which can be a portion of the light transmitting portion 31 that corresponds to the first surface 33 is recessed relative to a portion of the reflecting portion 32 that corresponds to the first surface 33, or a portion of the light transmitting portion 31 that corresponds to the second surface 34 is recessed relative to the reflecting portion 32 that corresponds to the first surface 33. The light transmitting portion 31 may be recessed with respect to a portion of the second surface 34, or the light transmitting portion 31 may be recessed with respect to a portion of the second surface 34. The reflecting portion 32 may be made of a material having reflective properties, or a reflective film may be provided in a portion of the area of the reflecting portion 32 corresponding to the first surface 33 or a portion of the area of the reflecting portion 32 corresponding to the second surface 34, so as to make the reflecting portion 32 have reflective functions. The light transmitting portion 31 may be made of a material having light-transmitting properties. In some embodiments, a translucent film may be provided in a portion of the light transmitting portion 31 corresponding to the first surface 33 or a portion of the light transmitting portion 31 corresponding to the second surface 34, so as to enhance the light transmission performance of the light transmitting portion 31.

In another exemplary embodiment, referring to FIG. 8, the light transmitting portion 31 is a light transmitting hole 35 in the beam splitter 30, and the light transmitting hole 35 is used for transmitting the detection light. By directly opening the light transmitting holes 35 on the beam splitter 30 to pass the detection light, light loss and processing cost can be reduced as compared to transmitting the detection light by providing a part of the beam splitter 30 with a light transmitting material. In one embodiment, the light-transmitting hole 35 has a circular cross-section in the radial direction.

In some embodiments, the interface between the light transmitting portion 31 and the reflecting portion 32 may be approximately cylindrical. For example, the interface may be a prismatic surface, a cylindrical surface, or the like.

In some embodiments, the interface between the light transmitting portion 31 and the reflecting portion 32 is a cylindrical surface, and the beam splitter 30 satisfies: 10 mm≤R≤12 mm, where R is the radial dimension of the interface between the light transmitting portion 31 and the reflecting portion 32. The design of the light transmitting portion 31 and the reflecting portion 32 defines the radial size of the interface R to be greater than or equal to 10 mm and less than or equal to 12 mm, thereby reducing the size of the light transmitting portion 31 in the middle of the beam splitter 30 (in related technology, the radial dimension of the interface between the light transmitting portion 31 and the reflecting portion 32 is usually in the range of 13 mm-15 mm). In the case of ensuring a certain emission efficiency, reducing the size of the light transmitting portion 31 in the middle of the beam splitter 30 is equivalent to reducing the object height of the beam splitter 30 for its rear mirror group, thereby reducing the size of the middle hole (corresponding to the light transmitting portion 31) of the spot incident on the receiver 22, increasing the area of the spot on the receiver 22, and enhancing the echo energy received by the receiver 22.

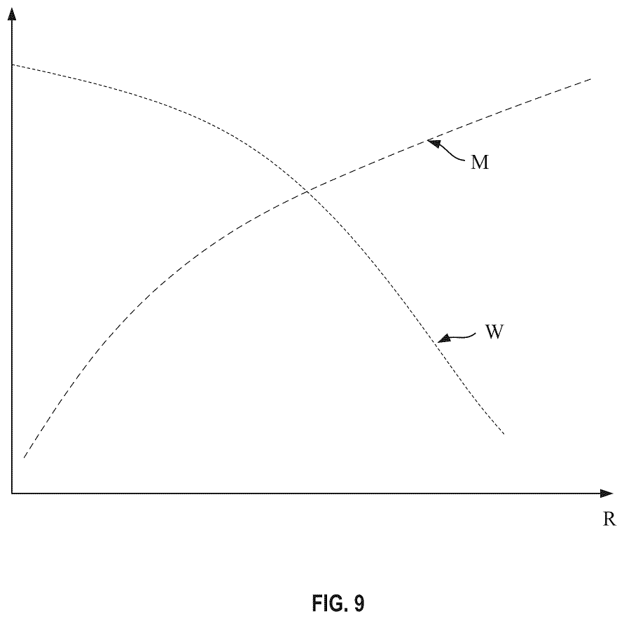

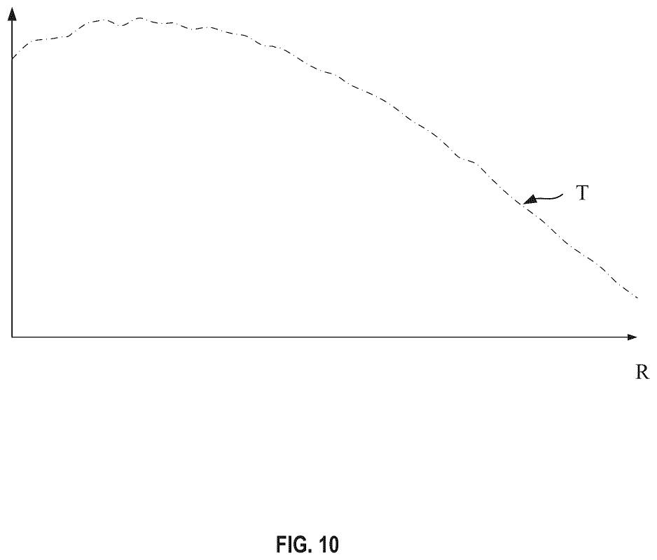

It should be noted that the radial dimension R of the interface between the light transmitting portion 31 and the reflecting portion 32 of the above-described design is greater than or equal to 10 mm and less than or equal to 12 mm, which is determined after taking into account the launching efficiency, the proximity return energy, and the transmitting and receiving efficiency. Specifically, referring to FIGS. 9 and 10, which illustrate the variation curve M of the emission efficiency with the radial dimension R of the interface between the light transmitting portion 31 and the reflecting portion 32, the variation curve W of the proximity return energy with the radial dimension R of the interface between the light transmitting portion 31 and the reflecting portion 32, and the variation curve T of the transceiving and receiving efficiency with the radial dimension R of the interface between the light transmitting portion 31 and the reflecting portion 32, since ensuring the long-distance ranging capability of the LiDAR 1 requires a high degree of flexibility in the measurement of the distance. Because ensuring the long-range ranging capability of the LiDAR 1 requires high transceiver efficiency, it is necessary to judge the position of the intersection of these three curves to determine the radial dimension R of the interface between the light transmitting portion 31 and the reflecting portion 32. In order to avoid the problem of leading light and stray light caused by an excessive decrease in the transmitting efficiency, the radial dimension R of the interface between the light transmitting portion 31 and the reflecting portion 32 should also be satisfied with the transmitting efficiency of the interface of this size of not less than 80%. Combining the location of the intersection of the above three curves and the emission efficiency, the embodiment of the present application determines the radial dimension R of the interface between the light transmitting portion 31 and the reflecting portion 32 to be greater than or equal to 10 mm and less than or equal to 12 mm, in order to realize the enhancement of the light efficiency in the near distance and the balance of the emission efficiency, the return energy in the near distance, and the transmitting/receiving efficiency.

In some embodiments, referring to FIG. 1, the scanning module 40 includes a rotating mirror 42 and a galvanometer 41. The rotating mirror 42 is used to rotate in an axis of a first straight line x, the rotating mirror 42 has a plurality of second reflective surfaces 421 provided around the first straight line x, which is perpendicular to a plane where an optical axis of the LiDAR 1 is located. The galvanometer 41 is used to rotate in an axis of a second straight line y, the galvanometer 41 has a first reflective surface 411, and the second straight line y is perpendicular to the first straight line x. One of the first straight line x and the second straight line y is horizontal, and the other is vertical, to achieve a view along a vertical direction and a horizontal direction, respectively. The second straight line y is perpendicular to the first straight line x.

In some embodiments, the two adjacent second reflective surfaces 421 of the rotating mirror 42 are connected by the transition surface 422. Compared to the adjacent two second reflective surfaces 421 directly connected to form a sharp corner, where the sharp corner is prone to form a diffuse reflection, the setup of the transition surface 422 is conducive to achieving the reflective control of the beam. The second reflective surface 421 is used to reflect the detection light and return light, the transition surface 422 can be used to balance the LiDAR volume, reduce the load burden of the rotating mirror 42 motor, and reduce the risk of stray light. The transition surface 422 can be a plane, a curved surface, a combination of a plane and a curved surface, and the size of the transition surface 422 is related to the spot size of the detected light.

In some embodiments, referring to FIG. 1, the LiDAR 1 further includes a first extinction unit 50, the first extinction unit 50 being disposed between the emission unit 11 and the emission lens 12. The first extinction unit 50 is used to eliminate stray light between the emission unit 11 and the emission lens 12.

In some embodiments, referring to FIG. 1, the first extinction unit 50 is provided with a first through-hole 51 for detecting the passage of light, and at least one extinction groove 511 is provided on an inner wall surface of the first through-hole 51. Among them, when a plurality of extinction grooves 511 is provided on the inner wall surface of the first through-hole 51, the extinction grooves 511 can be provided in sequence along an extension direction of the first through-hole 51. The extinction groove 511 may be a ring-shaped groove, and the cross-section of the extinction groove 511 may be curved, polygonal, etc., where the polygon may be rectangular, triangular, etc. The extinction groove 511 may be a ring-shaped groove.

In some embodiments, the first extinction unit 50 has a first end face 52 and a second end face 53 back-to-back along a transmission path of the detected light. The first end face 52 is provided with a first mounting groove connected to the first through-hole 51, and at least a portion of the emission unit 11 is located in the first mounting groove. The setting of the first mounting slot can play a positioning effect on the mounting position of the emission unit 11, and improve the assembly precision, assembly efficiency, and assembly stability of the emission unit 11 and the first extinction unit 50. The second end face 53 is provided with a second mounting groove 531 connected to the first through-hole 51, and at least a portion of the emission lens 12 is located in the second mounting groove 531. The setting of the second mounting groove 531 can play a positioning effect on the mounting position of the emission lens 12 to enhance the assembly efficiency of the emission lens 12 and the first extinction unit 50, the assembly efficiency, and the assembly solidity. In some embodiments, the first extinction unit 50 may also be provided with a weight reduction hole or the like to reduce the weight of the first extinction unit 50.

In some embodiments, referring to FIG. 1, the LiDAR 1 further includes a second extinction unit 60, the second extinction unit 60 being disposed between the receiving surface 221 of the receiver 22 and the beam splitter 30. The second extinction unit 60 is used to eliminate stray light between the receiving surface 221 of the receiver 22 and the beam splitter 30.

In some embodiments, the second extinction unit 60 is used to block light signals in the non-primary light region from being emitted to the receiving surface 221 of the receiver 22, where the energy percentage of the return light in the light signals in the non-primary light region is less than the first pre-determined value. It should be noted that the first pre-determined value can be selected according to the actual demand. For example, the first pre-determined value can be 6%, 8%, 10%, 12%, 14%, etc., without limitation.

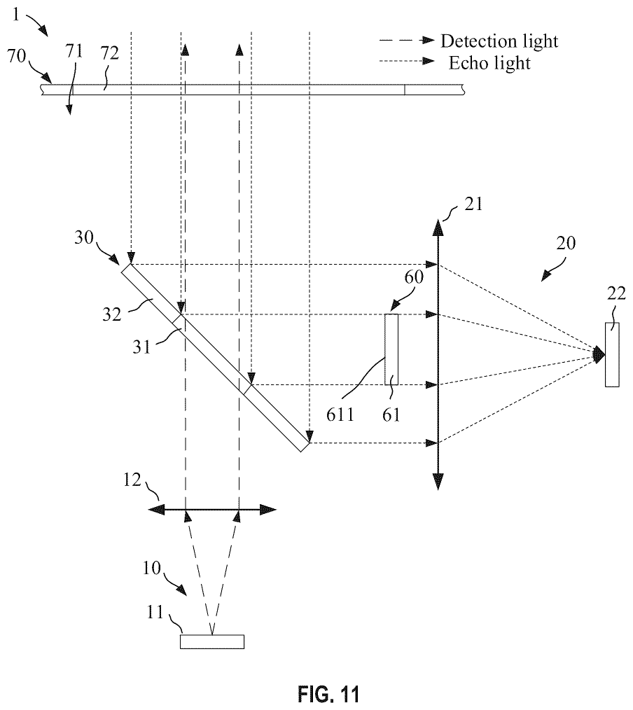

Referring to FIG. 11, in some embodiments, the second extinction unit 60 includes a first extinguisher 61 disposed between the beam splitter 30 and the receiving lens 21. By blocking light signals in a non-primary light region from being emitted to the receiver 22 by the first extinguisher 61, stray light in the non-primary light region (such as, for example, the leading light) is avoided from being received by the receiver 22, and the influence of the stray light on the detection result of the LiDAR 1 is weakened, and the detection accuracy of the LiDAR 1 is improved. And because the energy of the return light in the region of the non-primary light accounts for a relatively small amount, even if the receiving surface 221 of the receiver 22 does not receive this part of the return light energy, there is almost no impact on the detection performance of the LiDAR 1. It is to be understood that in determining the specific mounting position of the first extinguisher 61, it is first necessary to determine the non-dominant light region between the receiving surface 221 of the receiver 22 and the beam splitter 30. The non-primary light region can be obtained by fitting the optical path through the simulation system. Specifically, the optical path between the receiving surface 221 of the receiver 22 and the beam splitter 30 can be fitted through the simulation system to obtain the energy ratio of the return light in the optical path between the receiving surface 221 of the receiver 22 and the beam splitter 30 in various regions, and according to the energy ratio of the return light is divided into the primary light region and the non-primary light region. For the optical signal in the primary light region, the energy percentage of the return light is greater than or equal to the second pre-determined value. The second pre-determined value can be selected according to actual demand. For example, the second predefined value can be 86%, 88%, 90%, 92%, 94%, and so on.

The above first extinguisher 61 can be used not only to block the light signals of the non-primary light region from being emitted to the receiver 22, but also to block the light signals of at the edge of the primary light region, which is close to the non-primary light region in the primary light region, from being emitted to the receiver 22, in order to obtain a better elimination of the light crosstalk effect. It is to be noted that if the first extinguisher 61 is also used to block the light signals of the edge main light ray region from being transmitted to the receiver 22, the area ratio of the edge main light ray region in the main light ray region is less than or equal to the third pre-determined value, so as to ensure that the energy of the echo light received by the LiDAR 1 is sufficient while better eliminating the effect of light crosstalk. The third predefined value can be selected according to actual demand. For example, the third predefined value can be 26%, 28%, 30%, 32%, 34%, and so on.

Referring to FIG. 11, in some embodiments, the first extinguisher 61 includes a first extinction section 611, which is used to block light signals emitted from the light transmitting portion 31 of the beam splitter 30 to the receiver 22. Since the light signals emitted from the light transmitting portion 31 to the receiver 22 are not return light, the first extinction section 611 is designed to block the light signals emitted from the light transmitting portion 31 to the receiver 22, so as to eliminate crosstalk of the return light by the light signals emitted from the light transmitting portion 31 to the receiver 22. It should be noted that, in the actual manufacturing process, the light transmitting device (e.g., the light transmitting portion 31 of the beam splitter 30, the window 72) is difficult to achieve 100% light transmission, and there will always be a certain reflectivity, which will result in the emitted light not being sent out of the housing 70, but after a certain amount of transmission in the interior of the housing 70, it will arrive at the receiver 22. That is, there is a leading light, and the leading light will have a negative effect on the echoed light received by the receiver 22. This leading light will cause crosstalk to the return light received by the receiver 22. Among them, the leading light is mainly transmitted inside the housing 70, and the transmission time is similar to the detection time of the close-range target object, which is likely to affect the detection accuracy of the close-range target object, resulting in the detection of the close-range target object blind zone.

In some other embodiments, referring to FIG. 1, the second extinguisher 62 is provided between the beam splitter 30 and the receiving lens 21, and the second extinguisher 62 includes at least one extinction unit 621 including a plurality of extinguishing teeth 6211 spaced apart along the transmission path of the return light, and the extinguishing teeth 6211 can reflect at least a portion of the stray light at least once, so as to cause the stray light to be transmitted in a direction away from the receiver 22 or to reduce the intensity of the stray light, so as to reduce the interference of the stray light with the return light, and improve the detection accuracy of the LiDAR 1. The extinguishing teeth 6211 may reflect at least part of the stray light at least once, causing the stray light to be transmitted in a direction away from the receiver 22 or reducing the intensity of the stray light, so as to reduce the interference of the stray light with the return light, and improve the detection accuracy of the LiDAR 1.

In some embodiments, referring to FIG. 1, the LiDAR 1 further includes a housing 70, the housing 70 including a mounting cavity 71 and a window 72; the emission module 10, the receiving module 20, the beam splitter 30, and the scanning module 40 are disposed within the mounting cavity 71.

In some embodiments, the angle between the normal vector at a first point on the window 72 and the detected light is greater than a predetermined value, where the first point is the intersection of the detected light and the surface of the window 72 proximate to the mounting cavity 71, and the predetermined value is based on the energy of the detected light.

The formation of the leading phenomenon caused by the window 72 is mainly due to the following: when the detection light has different angles and positions, part of the detection light may form a perpendicular incidence with the local surface of the window 72, so that this portion of the detection light is not transmitted out, but to produce a strong reflection inside the LiDAR 1. The receiver then receives this strong echo energy in a short period of time, resulting in saturation of the receiver and causing the LiDAR to lose its detection capability within that time range. It is understood that the larger the angle between the normal vector at the first point on the window 72 and the detected light, the smaller the probability that the reflected light will be detected by the receiver. In this embodiment, through targeted surface optimization of the window 72 of the LiDAR 1, the inner surface of the window 72 is non-uniformly curved to increase the angle of the normal vector at the intersection of the detected light and the inner surface of the window 72. This ensures that, for different fields of view of the detected light, the angle of the normal vector at the surface of the window 72 is greater than a preset angle, thereby avoiding perpendicular incidence of light as much as possible from the design perspective, and minimizing the influence of the leading phenomenon.

The exact value of the preset value relates to the leading saturation energy and range requirements of different types of LiDAR. In some embodiments, the preset values range from 3° to 10°. For example, the preset value may be 5°, 8°, and so forth. Setting the angle between the normal vector at the first point on the window 72 and the detected light to be greater than the preset value can effectively reduce the leading phenomenon brought by the refractive optical path caused by the window, and reduce the blind spot of the whole LiDAR.

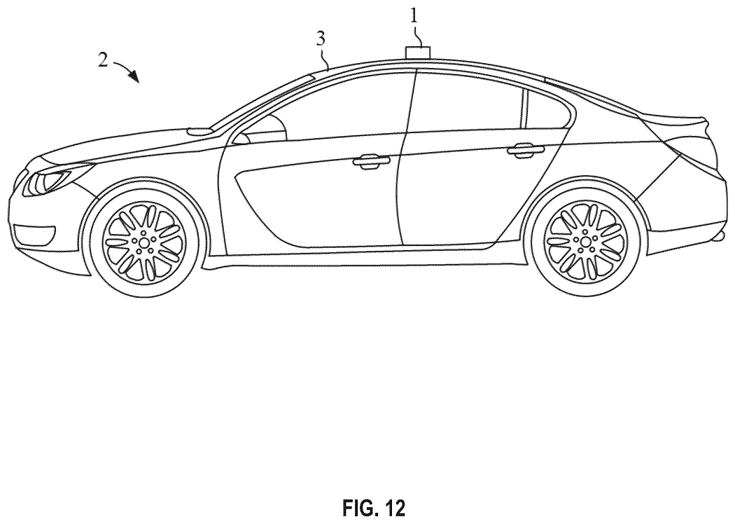

Referring to FIG. 12, embodiments of the present application also provide a movable device 2, the movable device 2 including an apparatus body 3 and the above-described LiDAR 1, and the LiDAR 1 is connected to the apparatus body 3. In some embodiments, the movable device 2 may be a car, an electric vehicle, a drone, a robot, and any movable tool that can be equipped with the above-described LiDAR 1.

The same or similar reference numerals in the drawings of the present application refer to the same or similar parts. In the description of the present application, it should be understood that if the terms “upper,” “lower,” “left,” “right,” and the like indicate directions or positional relationships based on the directions or positional relationships shown in the drawings. These terms are not intended to indicate or imply any particular spatial orientation or specific mode of construction or operation of the referenced device or component. Accordingly, such directional terms are intended only for illustrative purposes and should not be construed as limiting the scope of the present application. Those skilled in the art will understand the appropriate interpretation of such terms based on the particular context in which they are used.

The above description is provided merely as exemplary embodiments of the present application and is not intended to limit the scope of the present application. Any modifications, equivalent substitutions, and improvements that fall within the spirit and scope of the present application shall be encompassed within the scope of protection as defined by the appended claims.

What is claimed is:

1. A LiDAR, comprising:
an emission module, configured to emit detection light;
a receiving module, configured to receive echo light formed by reflected detection light from a target object, wherein the receiving module comprises a receiving lens and a receiver, the receiving lens is located on a light-entry side of the receiver, the receiving lens satisfies a conditional formula: 40 mm≤f_{RX}≤80 mm, wherein f_{RX} is an effective focal length of the receiving lens;
a beam splitter, comprising a light transmitting portion and a reflecting portion, the reflecting portion being disposed at a periphery of the light transmitting portion, the light transmitting portion being configured to transmit detected light, and the reflecting portion being configured to reflect the echo light; and
a scanning module, configured to emit the detected light to the target object, and to transmit the echo light to the receiving module.

2. The LiDAR according to claim 1, wherein the light transmitting portion is separated from the light reflecting portion by an interface, and the interface is a cylindrical surface; and
wherein the beam splitter satisfies:
$$10 mm \leq R \leq 12 mm ,$$
wherein R is a radial dimension of the interface between the light transmitting portion and the reflecting portion.

3. The LiDAR according to claim 1, wherein the light transmitting portion is a light transmitting hole on the beam splitter, the light transmitting hole having a circular cross-section along a radial direction.

4. The LiDAR according to claim 1, wherein the receiver has a receiving surface, the receiving surface satisfying:
$$0.05 mm \leq {H}_{1} \leq 0.2 mm ,$$
wherein H₁ is a spacing between a center of a first spot and a center of the receiving surface in a first direction, the first spot being a spot of the echo light incident on the receiving surface, and the first direction being a dimensional direction of the receiving surface.

5. The LiDAR according to claim 4, wherein the emission module comprises:
an emission unit, comprising a plurality of lasers configured to generate the detecting light; and
an emitting lens, located on a light-out side of the emission unit, for emitting the detecting light,
wherein the lasers are arranged in a linear arrangement or in a two-dimensional array.

6. The LiDAR according to claim 1, wherein the scanning module comprises:
a rotating mirror, configured to rotate on a first straight line, the rotating mirror having second reflective surfaces disposed around the first straight line, and the first straight line being perpendicular to a plane in which an optical axis of the LiDAR is located; and
a galvanometer, configured to rotate on a second straight line, the galvanometer having a second reflective surface, and the second straight line being perpendicular to the first straight line.

7. The LiDAR according to claim 6, wherein two adjacent second reflective surfaces are connected via a transition surface.

8. The LiDAR according to claim 5, further comprises a first extinction unit and a second extinction unit,
wherein the first extinction unit is located between the emission unit and the emitting lens; and
the second extinction unit is located between the receiving surface and the receiving lens.

9. The LiDAR according to claim 1, further comprises a housing, wherein the housing comprises a mounting cavity and a window,
the emission module, the receiving module, the beam splitter and the scanning module are provided in the mounting cavity; and
an angle between a normal vector at a first point on the window and the detected light is greater than a predetermined value, wherein the first point is the point of intersection of the detected light with a surface of a window proximate to the mounting cavity, the predetermined value being determined based on energy of the detected light.

10. A movable device, comprising an apparatus body and a LiDAR, wherein the LiDAR is connected to the apparatus body, and the LiDAR comprises:
an emission module, configured to emit detection light;
a receiving module, configured to receive echo light formed by reflected detection light from a target object, wherein the receiving module comprises a receiving lens and a receiver, the receiving lens is located on a light-entry side of the receiver, the receiving lens satisfies a conditional formula: 40 mm≤f_{RX}≤80 mm, wherein f_{RX} is an effective focal length of the receiving lens;
a beam splitter, comprising a light transmitting portion and a reflecting portion, the reflecting portion being disposed at a periphery of the light transmitting portion, the light transmitting portion being configured to transmit the detected light, and the reflecting portion being configured to reflect the echo light; and
a scanning module, configured to emit the detected light to the target object, and to transmit the echo light to the receiving module.
